(19) United States
(12) Patent Application Publication
(10) Pub. No.: US 2013/0106819 A1
(43) Pub. Date: May 2, 2013

(54) DISPLAY PANEL AND DISPLAY APPARATUS HAVING THE SAME

(71) Applicant: SAMSUNG ELECTRONICS CO., LTD., Suwon-si (KR)

(72) Inventors: Dong-ki LEE, Seoul (KR); Su-hong KO, Suwon-si (KR); Jeong-dong NOH, Suwon-si (KR); Woo-jae LEE, Seoul (KR); Hyo-jae JANG, Gangneung-si (KR)

(73) Assignee: SAMSUNG ELECTRONICS CO., LTD., Suwon-si (KR)

(21) Appl. No.: 13/660,467

(22) Filed: Oct. 25, 2012

(30) Foreign Application Priority Data
Oct. 26, 2011 (KR) 10-2011-0109873

(51) Int. Cl. G06F 3/038

(52) U.S. Cl. 345/211

(57) ABSTRACT

The display panel includes: a gate line; a data line which crosses the gate line and receives a data voltage from a data driver; a thin film transistor (TFT) which is formed at an intersection between the gate line and the data line; a common voltage unit which supplies a common voltage; a capacitor; and a switching unit which shuts off a supply of the data voltage and the common voltage and changes a charging electric potential of the capacitor into a black electric potential upon receiving a data signal corresponding to a black frame formed between image frames.

### CROSS-REFERENCE TO RELATED APPLICATION

This application claims priority from Korean Patent Application No. 10-2011-0109873, filed on Oct. 26, 2011 in the Korean Intellectual Property Office, the disclosure of which is incorporated herein by reference in its entirety.

### BACKGROUND

1. Field

Apparatuses consistent with exemplary embodiments relate to a display panel and a display apparatus having the same, and more particularly, to a display panel and a display apparatus which consume less power.

2. Description of the Related Art

In recent years, there has been an increasing demand for display apparatuses which display a 3D image. The 3D image provides a 3D effect for an object by using binocular disparity which is the main factor for a user to recognize the 3D effect from a short distance. Recognition of 3D image is largely divided into polarized method and frame sequential method. In the case of the frame sequential method, a left eye image and a right eye image are alternately displayed to provide a 3D effect. For example, a liquid crystal display (LCD) apparatus including an LCD panel sequentially displays a left eye image, a black image, a right eye image and a black image (LBRB) to reduce occurrence of cross talk of a left eye image and a right eye image when displaying a 3D image by the frame sequential method.

To reduce the occurrence of cross talk, the related art display panel displays a black frame by supplying a data signal to a data line corresponding to such black frame, and the power is supplied accordingly. Driving the display panel consumes 20 to 40% of the total power consumed by the display apparatus. Accordingly, when a 3D image signal is displayed by the LCD apparatus by using the LBRB method, to reduce the cross talk, a black image is additionally displayed between the left and right eye images, which causes more power consumption of the LCD apparatus.

### SUMMARY

Accordingly, one or more exemplary embodiments provide a display panel and a display apparatus thereof which consume less power, for displaying a 3D image signal.

The foregoing and/or other aspects may be achieved by providing a display panel comprising: a gate line; a first data line which crosses the gate line and receives a first data voltage from a data driver; a first thin film transistor (TFT) which is formed at an intersection between the gate line and the first data line; a common voltage unit which supplies a common voltage; a capacitor; and a switching unit which shuts off a supply of the first data voltage and the common voltage and changes a charging electric potential of the capacitor into a black electric potential upon receiving a data signal corresponding to a black frame formed between image frames.

The switching unit may comprise a first switch device which is connected between the first data line and the data driver and switches the first data voltage on and off.

The display panel may further comprise a common voltage line which connect the first TFT and the common voltage unit and supply the common voltage, wherein the switching unit further comprises a second switch device which is connected between the common voltage line and the first TFT and switches the common voltage on and off.

The switching unit may further comprise a third switch device which is connected between the first data line and the common voltage line, and the third switch device may connect the first TFT and a second TFT which is connected to a second data line adjacent to the first TFT and change the charging electric potential of the capacitor into the black electric potential upon receiving the data signal of the black frame.

A polarity of the first data voltage may be opposite to a polarity of a second data voltage that is applied to the second data line adjacent to the first TFT.

Another aspect may be achieved by providing a display apparatus comprising: a gate line; a first data line which crosses the gate line and receives a first data voltage from a data driver; a first thin film transistor (TFT) which is formed at an intersection between the gate line and the first data line; a common voltage unit which supplies a common voltage; a capacitor which charges when the first data voltage is supplied; and a display panel which shuts off the first data voltage and the common voltage and changes a charging electric potential of the capacitor into a black electric potential upon receiving a data signal corresponding to a black frame which is formed between image frames.

The switching unit may comprise a first switch device which is connected between the first data line and the data driver and switches the first data voltage on and off.

The display panel may further comprise a common voltage line which connects the first TFT and the common voltage unit and supplies the common voltage, and the switching unit may further comprise a second switch device which is connected between the common voltage line and the first TFT and switches the common voltage on and off.

The switching unit may further comprise a third switch device which is connected between the first data line and the common voltage line, and the third switch device connects the first TFT and a second TFT that is connected to a second data line adjacent to the first TFT and changes the charging electric potential of the capacitor into the black electric potential upon receiving the data signal of the black frame.

A polarity of the first data voltage is opposite to a polarity of a second data voltage that is applied to the second data line adjacent to the first TFT.

Still another aspect may be achieved by providing a display panel comprising: thin film transistors (TFT) which are formed neighboring one another and each has a gate electrode connected to a corresponding gate line and a source electrode connected to a corresponding data line; capacitors which is each connected between a drain electrode of a corresponding TFT and a common voltage line and charges an electric potential when data voltage and common voltage are supplied to the corresponding TFT, during image frames; and a switching unit which turns off a data voltage source and a common voltage source and controls the capacitors of adjacent neighboring TFTs to change a charged electric potential into a black electric potential corresponding to a black frame to be displayed between the image frames.

Electric power supply to the TFTs and to the capacitors may be shut off during the displaying of the black frame.

The switching unit may comprise: a first switch device which is connected between the data voltage source and the source electrodes of the TFTs; a second switch device which is connected between the common voltage source and the capacitors; and a third switch device comprising switches which each is connected between the corresponding data line and the common voltage source.

The switches of the third switch device may connect a pair of the adjacent neighboring TFTs to change the charging electric potential of the capacitors into the black electric potential upon receiving a data signal of the black frame, while the first switch device and the second switch device disconnect the data voltage source and the common voltage source.

A polarity of the charged electric potential of the capacitor connected to a first TFT of the pair may be opposite to a polarity of the charged electric potential of the capacitor connected to a second TFT of the pair.

### BRIEF DESCRIPTION OF THE DRAWINGS

The above and/or other aspects will become apparent by describing certain exemplary embodiments, with reference to the accompanying drawings, in which:

FIG. 1 illustrates a display panel according to an exemplary embodiment;

FIG. 2 illustrates a display apparatus which includes the display panel of FIG. 1;

FIG. 3 illustrates a flow of a signal for displaying a 3D image signal of the display apparatus;

FIGS. 4A and 4B illustrate an operation of a switching unit of the display panel of FIG. 1; and

FIGS. 5A and 5B illustrate a change in a charging electric potential of a capacitor of the display panel of FIG. 1.

### DETAILED DESCRIPTION

Certain exemplary embodiments are described in detail below with reference to the accompanying drawings.

In the following description, like drawing reference numerals are used for the like elements, even in different drawings. The matters defined in the description, such as detailed construction and elements, are provided to assist in a comprehensive understanding of exemplary embodiments. However, exemplary embodiments can be carried out without those specifically defined matters. Also, well-known functions or constructions are not described in detail since that would obscure the invention with unnecessary detail.

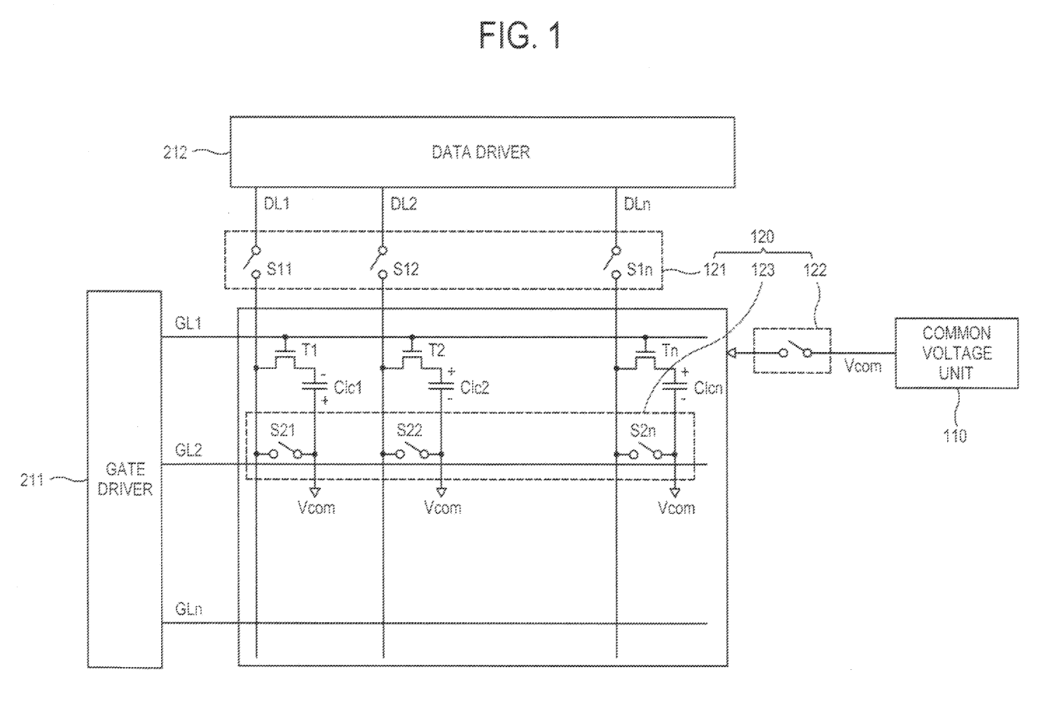

FIG. 1 illustrates a display panel 100 according to an exemplary embodiment.

The display panel 100 includes a liquid crystal display (LCD) panel in which liquid crystal cells are arranged in a matrix form. The display panel 100 includes a plurality of gate lines GL1, GL2, . . . and GLn, a plurality of data lines DL1, DL2, . . . and DLn, a plurality of thin film transistors (TFT) T1, T2, . . . and Tn, a plurality of capacitors Clc1, Clc2, . . . and Clcn and a switching unit 120.

The plurality of gate lines GL1, GL2, . . . and GLn receives a plurality of gate signals from a gate driver 211.

The plurality of data lines DL2, DL2, . . . and DLn crosses the plurality of gate lines and receives a data voltage from a data driver 212 corresponding to a data signal.

The plurality of TFTs T1, T2, . . . and Tn is formed at an intersection of the gate lines GL1, GL2, . . . and GLn and the data lines DL1, DL2, . . . and DLn. The capacitors Clc1, C1c2, . . . and Clcn which are connected between the TFTs and a common voltage unit 110 supplying a common voltage form collectively a single pixel. A gate electrode of the each TFT is connected to the gate lines GL1, GL2, . . . and GLn, and a source electrode of the TFT is connected to the data lines DL1, DL2, . . . and DLn. Each pixel area (not shown) is formed at an intersection of the gate lines GL1, GL2, . . . and GLn and the data lines DL1, DL2, . . . and DLn, and a pixel electrode is formed in the pixel area.

The plurality of capacitors Clc1, Clc2, . . . and Clcn includes the pixel electrode, a common electrode which receives a common voltage Vcom from the common voltage unit 110, and liquid crystal which is interposed between the pixel electrode and the common electrode.

If a predetermined signal is applied from the gate lines GL1, GL2, . . . and GLn and the data lines DL1, DL2, . . . and DLn to turn on the TFTs T1, T2, . . . and Tn, a data voltage Vd which is supplied to the data lines DL1, DL2, . . . and DLn is applied to a pixel electrode through the TFTs. An electric field which falls under a difference between a pixel voltage Vp applied to the pixel electrode and a common voltage Vcom supplied by the common voltage unit 110 is applied to the capacitors Clc1, Clc2, . . . and Clcn and light passes through at the transmissivity ratio corresponding to the strength of the electric field. The pixel voltage Vp is maintained for a single frame. Another capacitor may be further provided to maintain the pixel voltage Vp applied selectively to the pixel electrode.

The common voltage unit 110 may further include a common voltage line (not shown) to supply a common voltage Vcom to the display panel and supply the common voltage by connecting the TFTs T1, T2, . . . and Tn and the common voltage unit 110.

The switching unit 120 shuts off a data voltage Vd supplied by the data driver 212 and the common voltage Vcom supplied by the common voltage unit 110, and changes a charging electric potential applied to the capacitors Clc1, C1c2, . . . and Clcn into a black electric potential upon receiving a data signal corresponding to a black frame formed between image frames.

The switching unit 120 includes a first switch device 121, a second switch device 122 and a third switch device 123.

The first switch device 121 is connected between the data lines DL1, DL2, . . . and DLn and the data driver 212 and switches on/off the data voltage Vd output by the data driver 212. The first switch device 121 includes a plurality of switches S11, S12, . . . and S1N corresponding to each of the data lines DL1, DL2, . . . and DLn.

The second switch device 122 is connected between a common voltage line which supplies a common voltage Vcom of the common voltage unit 110 and the TFTs T1, T2, . . . and Tn and switches on/off the supply of the common voltage Vcom.

The third switch device 123 includes a plurality of switches S21, S22, . . . and S2N, is connected between the data lines DL1, DL2, . . . and DLn and the common voltage line, and upon receiving a data signal of the black frame, connects the TFTs T1, T2, . . . and Tn and a TFT connected to a data line adjacent to the TFTs T1, T2, . . . and Tn to change the charging electric potential of the capacitor into a black electric potential.

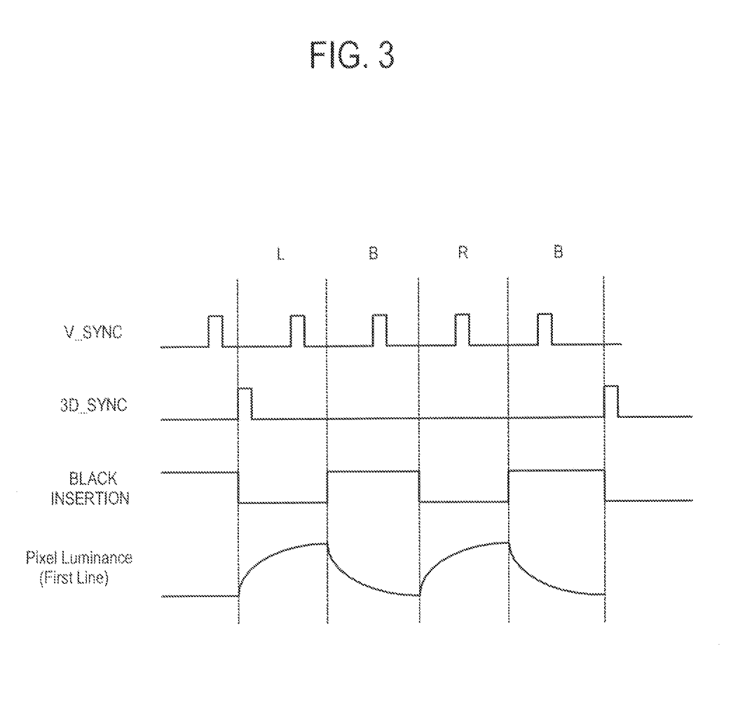

The operation of the switching unit 120 is described in more detail with reference to FIGS. 3 to 5.

The display panel 100 according to an exemplary embodiment is driven by a dot inversion method, by which a polarity of a data voltage supplied by a data line is opposite to a polarity of a data voltage supplied by an adjacent data line. Otherwise, the capacitor Clc1 receives a data voltage to be charged with a pixel electrode −Vp with a negative polarity, and the capacitor Clc2 receives a data voltage to be charged with a pixel electrode +Vp with a positive polarity.

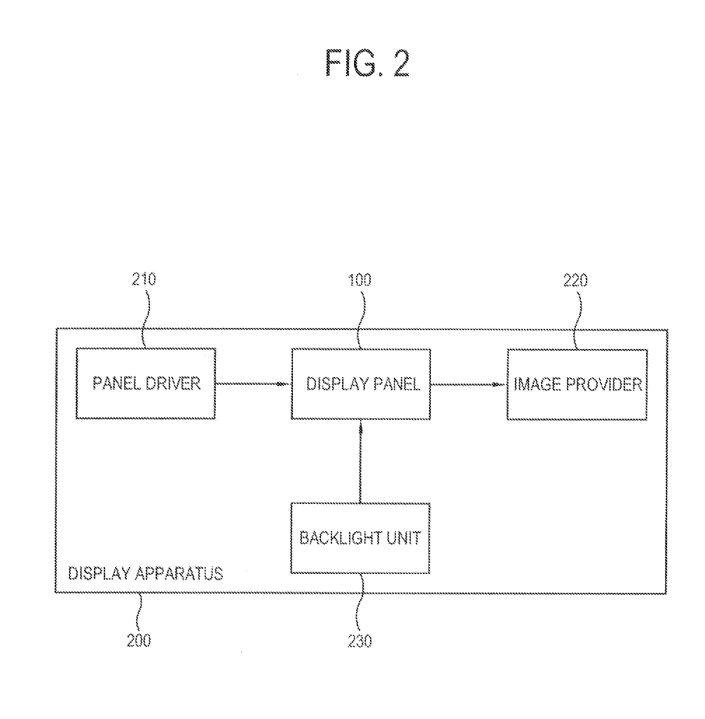

An exemplary embodiment further relates to a display apparatus 200 which includes the display panel 100 of FIG. 1, and is described with reference to FIG. 2.

Referring to FIG. 2, the display apparatus 200 includes the display panel 100 of FIG. 1, a panel driver 210, an image provider 220 and a backlight unit 230.

The panel driver 210 may include a gate driver 211, a data driver 212 and a timing controller (not shown) to drive the display panel 100.

The image provider 220 is connected to the display panel 100 and provides an image signal.

The backlight unit emits light to the display panel 100, and may include a generally known configuration. For example, the backlight unit may include a light guide plate which guides light, a light source which supplies light, a reflection sheet and optical sheet arranged below the light guide plate.

FIG. 3 illustrates a flow of a signal for displaying a display method for a 3D image signal of the display apparatus 200.

The display apparatus 200 according to an exemplary embodiment alternately displays a left eye image and a right eye image to display a 3D image. To reduce occurrence of L/R cross talk, the display apparatus 200 according to an exemplary embodiment displays a 3D image by the LBRB method by which a left eye frame, a black frame, a right eye frame and a black frame are sequentially displayed. The LBRB method applies a black frame to each of a left eye frame and a right eye frame and substantially reduces a white cross talk. FIG. 3 illustrates a flow of a signal by the LBRB method. As shown therein, if the display apparatus 200 displays a 3D image in a 3D mode, the timing controller of the panel driver 210 generates a black frame insertion signal that is switched by every single active frame (left eye frame or right eye frame), and the data driver 212 which receives the black frame insertion signal applies a data signal to the data line corresponding to the black frame for every single active frame in accordance with the timing.

When a conventional display panel displays a black frame by supplying a data signal to a data line corresponding to such black frame, the data driver and the common voltage unit consume power even in the black frame display area. Driving the display panel 100 consumes 20 to 40% of the total power consumed by the display apparatus 200. Therefore, if the power consumption of the display panel is reduced, the total power consumption of the display apparatus may be reduced. An exemplary embodiment improves economical efficiency in power consumption by reducing power consumed by the data driver 212 and the common voltage unit 110 in a display area of the black frame of the display panel.

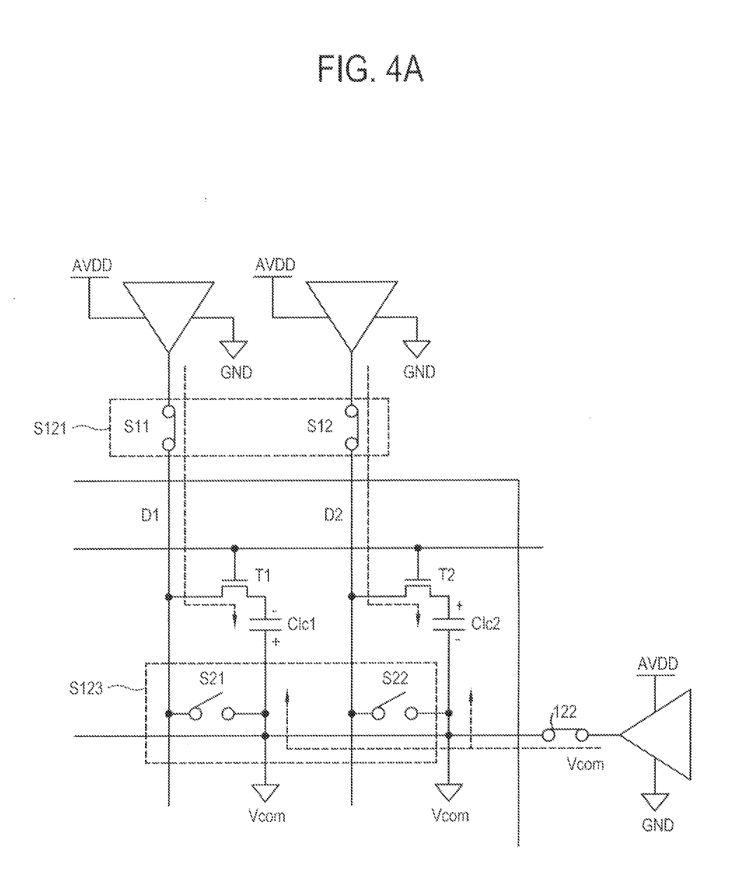

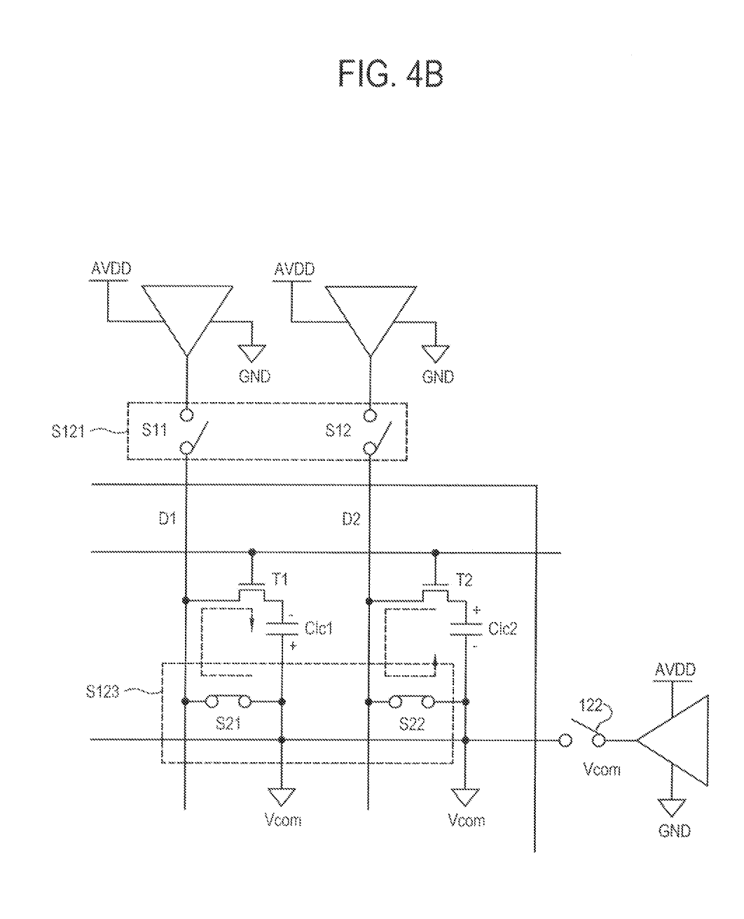

FIGS. 4A and 4B illustrate an operation of the display panel 100 of FIG. 1.

FIG. 4A illustrates an operation of the switching unit 120 when the display panel 100 displays an active frame (left eye frame or right eye frame). FIG. 4B illustrates an operation of the switching unit 120 when the display panel 100 displays a black frame.

As described above, the display panel 100 is driven by a dot inversion method, by which a polarity of a data voltage supplied to a first TFT T1 is opposite to a polarity of a data voltage supplied to a second TFT T2. The first capacitor Clc1 which is connected to a drain of the first TFT T1 is charged with a pixel electrode −Vp with a negative polarity, and a second capacitor Clc2 which is connected to a drain of the second TFT T2 is charged with a pixel electrode +Vp with a positive polarity.

The operation of the switching unit 120 is described with reference to FIG. 4A. The first switch device 121 of the switching unit 120 is connected between the data lines D1, D2, . . . and Dn and the data driver 212 and switches on/off the data voltage supplied by the data driver 212. The first switch device 121 includes a first switch S11 which is provided between the first data line D1 and the data driver 212, and a second switch S12 which is provided between the second data line D2 and the data driver 212.

The first switch device 121 determines whether the data driver 212 supplies a data voltage corresponding to an active frame (left eye frame or right eye frame) or supplies a data voltage corresponding to a black frame. If the data voltage corresponding to the active frame is supplied, the first switch device 121 is turned on to supply the data voltage to the TFTs T1, T2, . . . and Tn.

The second switch device 122 is connected between the TFTs T1, T2, . . . and Tn and the common voltage line supplying the common voltage Vcom from the common voltage unit 110, and switches on/off the common voltage Vcom. The second switch device 122 may be turned on or off in association with the first switch device 121. Accordingly, if the first switch device 121 is turned on, the second switch device 122 is turned on. If the first switch device 121 is turned off, the second switch device 122 is turned off. Otherwise, the second switch device 122 may receive a signal corresponding to the active frame and black frame from the timing controller and switch on/off the common voltage Vcom. If the data voltage corresponding to the active frame is supplied to the TFTs T1, T2, . . . and Tn, the second switch device 122 is turned on and supplies the common voltage Vcom.

The third switch device 123 is connected between the data lines D1, D2, . . . and Dn and the common voltage line. The third switch device 123 is turned off when the data voltage corresponding to the active frame is supplied to the TFTs T1, T2, . . . and Tn.

For example, if a data voltage of 15V is supplied from the data driver 212 to the first TFT T1 through the first data line D1, the first switch S11 is turned on and the data voltage is supplied to the first TFT T1. Also, the second switch device 122 is turned on and a common voltage Vcom of 7.5V is supplied by the common voltage unit 110 and the first capacitor Clc1 is charged with a pixel voltage of −7.5V. If a data voltage of 0V is supplied from the data driver 212 to the second TFT T2 through the second data line D2, the second switch S12 is turned on and the data voltage is supplied to the second TFT T2. Also, the second switch device 122 is turned on and a common voltage Vcom of 7.5V is supplied by the common voltage unit 110 and the second capacitor Clc2 is charged with a pixel voltage of +7.5V. Accordingly, light passes through at a transmissivity ratio corresponding to the strength to each pixel voltage and an image corresponding to an active frame is displayed.

An operation of the switching unit 120 is described with reference to FIG. 4B, which illustrates the operation of the switching unit 120 in the case of a black frame.

The first and second switches S11 and S12 detect a data voltage corresponding to a black frame from the data driver 212 and are turned off not to supply the data voltage to the TFTs T1, T2, . . . and Tn. The second switch device 122 is also turned off not to supply the common voltage Vcom to the TFTs T1, T2, . . . and Tn.

If a data voltage corresponding to a black frame from the data driver 212 is detected, the third and fourth switches S21 and S22 of the third switch device 123 are turned on. The capacitors Clc1 and Clc2 are still charged with pixel voltages of −7.5V and +7.5V corresponding to a previous active frame. Accordingly, data voltage of 15V and 0V are not applied to the first and second TFTs T1 and T2, respectively, and a common voltage of 7.5V is not applied by the common voltage unit 110. The third and fourth switches S21 and S22 are turned on to electrically connect the first TFT T1 and the second TFT T2 in an adjacent data line and supply the pixel voltage of +7.5V of the second capacitor Clc2 to the pixel voltage of −7.5V of the first capacitor Clc1, and the first and second capacitors Clc1 and Clc2 become 0V (black electric potential) and this gives the effect that the display panel displays a black frame.

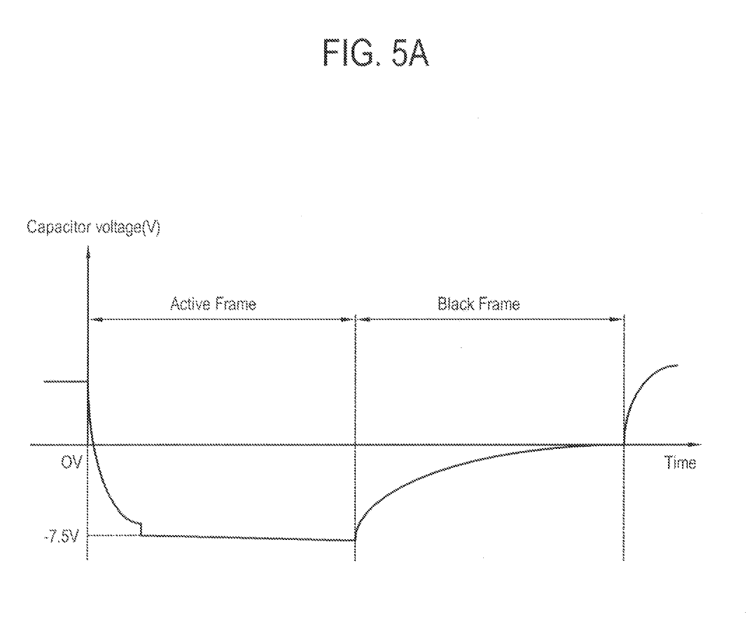

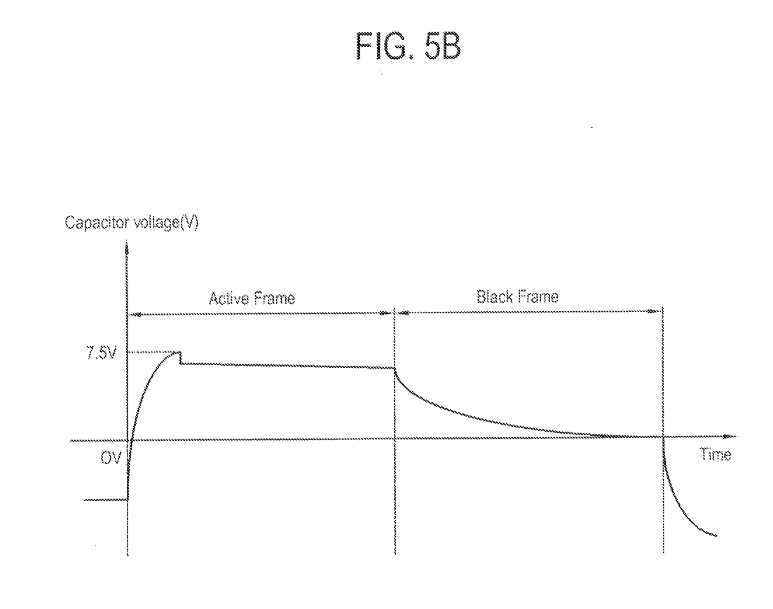

FIG. 5 illustrates a charging electric potential of the capacitor.

FIG. 5A illustrates a flow of a charging electric potential of the first capacitor Clc1, and FIG. 5B illustrates a flow of the charging electric potential of the second capacitor Clc2.

Referring to FIG. 5A, the first capacitor Clc1 is applied with a pixel voltage of −7.5V by the supply of the data voltage and common voltage in the display area of the active frame, and the voltage supplied by the data driver 212 and common voltage unit 110 is shut off in the display area of the black frame, and the pixel voltage of the first capacitor Clc1 becomes 0V due to the pixel voltage +7.5V of the second capacitor Clc2 as a result of the connection with the second TFT T2.

Referring to FIG. 5B, the second capacitor Clc2 is applied with a pixel voltage of +7.5V by the supply of the data voltage and common voltage in the display area of the active frame, and the voltage supplied by the data driver 212 and common voltage unit 110 is shut off in the display area of the black frame, and the pixel voltage of the second capacitor Clc2 becomes 0V due to the pixel voltage −7.5V of the first capacitor Clc1 as a result of the connection with the first TFT T1.

In a conventional display panel, the data driver supplies a data voltage of 7.5V to the TFT to change the pixel voltage of −7.5V corresponding to the active frame into a black electric potential of 0V corresponding to the black frame, or the data driver supplies a data voltage of 7.5V to the TFT to change the pixel voltage of +7.5V corresponding to the active frame into a black electric potential of 0V corresponding to the black frame. That is, the conventional display panel consumes power as the data driver and the common voltage unit supply voltage even in the display area of the black frame.

As shown in FIGS. 4A and 4B, however, in the display panel according to an exemplary embodiment, the data driver 212 and common voltage unit 110 do not supply voltage in the display area of the black frame, and the power consumed by the display panel in the display area of the black frame is almost zero. As a result, when a 3D image is displayed, power consumption of the display panel is reduced approximately by 50% or more, and the power consumption of the display apparatus may be reduced by at least 20% as compared to the related art display apparatus described above.

As described above, a display panel and a display apparatus thereof according to exemplary embodiments consume substantially less power when displaying a 3D image signal.

The foregoing exemplary embodiments and advantages are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A display panel comprising:
a gate line;
a first data line which crosses the gate line and receives a first data voltage from a data driver;
a first thin film transistor (TFT) which is formed at an intersection between the gate line and the first data line;
a common voltage unit which supplies a common voltage;
a capacitor; and
a switching unit which shuts off a supply of the first data voltage and the common voltage and changes a charging electric potential of the capacitor into a black electric potential upon receiving a data signal corresponding to a black frame formed between image frames.

2. The display panel according to claim 1, wherein the switching unit comprises a first switch device which is connected between the first data line and the data driver and switches the first data voltage on and off.

3. The display panel according to claim 2, further comprising a common voltage line which connects the first TFT and the common voltage unit and supplies the common voltage,
wherein the switching unit further comprises a second switch device which is connected between the common voltage line and the first TFT and switches the common voltage on and off.

4. The display panel according to claim 3, wherein the switching unit further comprises a third switch device which is connected between the first data line and the common voltage line, and
the third switch device connects the first TFT and a second TFT which is connected to a second data line adjacent to the first TFT and changes the charging electric potential of the capacitor into the black electric potential upon receiving the data signal of the black frame.

5. The display panel according to claim 4, wherein a polarity of the first data voltage is opposite to a polarity of a second data voltage that is applied to the second data line adjacent to the first TFT.

6. A display apparatus comprising:
a gate line;
a first data line which crosses the gate line and receives a first data voltage from a data driver;
a first thin film transistor (TFT) which is formed at an intersection between the gate line and the first data line;
a common voltage unit which supplies a common voltage;
a capacitor which charges when the first data voltage is supplied; and
a display panel which shuts off the first data voltage and the common voltage and changes a charging electric potential of the capacitor into a black electric potential upon receiving a data signal corresponding to a black frame which is formed between image frames.

7. The display apparatus according to claim 6, wherein the switching unit comprises a first switch device which is connected between the first data line and the data driver and switches the first data voltage on and off.

8. The display apparatus according to claim 7, wherein the display panel further comprises a common voltage line which connects the first TFT and the common voltage unit and supplies the common voltage, and
the switching unit further comprises a second switch device which is connected between the common voltage line and the first TFT and switches the common voltage on and off.

9. The display apparatus according to claim 8, wherein the switching unit further comprises a third switch device which is connected between the first data line and the common voltage line, and
the third switch device connects the first TFT and a second TFT that is connected to a second data line adjacent to the first TFT and changes the charging electric potential of the capacitor into the black electric potential upon receiving the data signal of the black frame.

10. The display apparatus according to claim 9, wherein a polarity of the first data voltage is opposite to a polarity of a second data voltage that is applied to the second data line adjacent to the first TFT.

11. A display panel comprising:
thin film transistors (TFT) which are formed neighboring one another and each has a gate electrode connected to a corresponding gate line and a source electrode connected to a corresponding data line;
capacitors which is each connected between a drain electrode of a corresponding TFT and a common voltage line and charges an electric potential when data voltage and common voltage are supplied to the corresponding TFT, during image frames; and
a switching unit which turns off a data voltage source and a common voltage source and controls the capacitors of adjacent neighboring TFTs to change a charged electric potential into a black electric potential corresponding to a black frame to be displayed between the image frames.

12. The display panel according to claim 11, wherein electric power supply to the TFTs and to the capacitors is shut off during the displaying of the black frame.

13. The display panel according to claim 11, wherein the switching unit comprises:
a first switch device which is connected between the data voltage source and the source electrodes of the TFTs;
a second switch device which is connected between the common voltage source and the capacitors; and
a third switch device comprising switches which each is connected between the corresponding data line and the common voltage source.

14. The display panel according to claim 13, wherein the switches of the third switch device connect a pair of the adjacent neighboring TFTs to change the charging electric potential of the capacitors into the black electric potential upon receiving a data signal of the black frame,
while the first switch device and the second switch device disconnect the data voltage source and the common voltage source.

15. The display panel according to claim 14, wherein a polarity of the charged electric potential of the capacitor connected to a first TFT of the pair is opposite to a polarity of the charged electric potential of the capacitor connected to a second TFT of the pair.
